(19) United States
(12) Patent Application Publication
(10) Pub. No.: US 2012/0215500 A1
(43) Pub. Date: Aug. 23, 2012

(54) CONFIGURATION OF CONSTRUCTION PRODUCTS FOR A DIGITAL BUILDING MODEL

(75) Inventors: Elisa Ciuti, Champs Sur Marne (FR); Florent Coudret, Champs Sur Marne (FR); Eric Lebegue, Champs Sur Marne (FR); Mathieu Marache, Champs Sur Marne (FR); Guillaume Picinbono, Champs Sur Marne (FR); Souheil Soubra, Champs Sur Marne (FR); Maixent Callaud, Millac (FR); Laurent Ortas, Paris (FR)

(73) Assignees: Centre Scientifique et Technique du Batiment(CSTB), Champs Sur Marne (FR); Placoplatre, Suresnes (FR); Saint-Gobain Isover, Courbevoie (FR)

(21) Appl. No.: 13/505,015

(22) PCT Filed: Nov. 2, 2010
(86) PCT No.: PCT/FR10/52344

§ 371 Date: Apr. 30, 2012

(51) Int. Cl. G06F 17/50

(52) U.S. Cl. 703/1

(57) ABSTRACT

A method and associated device relate to the enhancement of a digital model of a building using a computer, wherein: a) the digital model is analyzed in order to identify the elements that make up the building and have specific characteristics in the building; b) construction products which have properties that match said characteristics are defined; and c) the digital model is enhanced by adding, for every element that makes up the model, data from at least one list of suitable construction products.

The invention relates to the processing of digital data, applicable to the sector of construction and construction products, and concerns lifecycle management for a construction project based on the use of a digital building model.

The term “construction product” is understood to mean construction materials as well as a more complex construction system (for example a wall arranged to accommodate a water supply and therefore including at least one water barrier panel).

New ecological policies are leading the construction industry to make rapid adjustments in order to migrate from the current and/or future building types to buildings that are low energy or energy-plus, highly environmental, healthy, and meet a set of requirements (stability, safety, soundproofing, etc.).

The advanced technology offered by this progression provides a major opportunity for modernizing the building process, with significant change to the entire design chain from construction to placing the building in operation.

Currently, this chain is greatly handicapped by its sequential approach, due to an incompatibility between the software components used by the designer, by the supplier of the construction products, and by the specifier declaring the specifications and/or regulations and standards to be met for the building. As represented in FIG. 1, this incompatibility gives rise to the issue of reentering the necessary information in each step as the project advances (from the design and construction to the operation of a building construction project), which results in lost time and the inevitable deterioration of the information, often related to errors in interpretation. In fact, as illustrated in FIG. 1, where the arrows RS indicate the need to reenter information:
entity A is the computer workstation for a contracting client, for example;

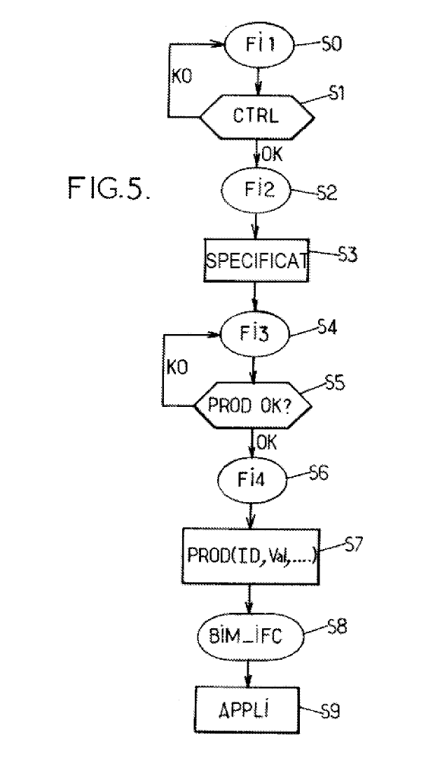

An example of an embodiment of the device DEV of the invention is represented in FIG. 6, in the form of a computer comprising:
a memory MEM storing a software program of the invention,
a processor PROC for executing the software,
a communication interface, for example for communicating with a wide-area network (such as the Internet), to access data in the database DB2 of the supplier in order to implement the invention when this computer DEV is the tool of a specifier,
as well as other peripherals such as a monitor SCR and a means for entering data (keyboard or other, not represented).

However, in one possible variant, the software of the invention may be stored on a server so that it can be shared by multiple remote workstations (the workstations of an architect, a specifier, a subcontractor, a supplier, etc.).
entity B is the workstation for an architect entering the data obtained from workstation A in order to create a digital model (for example in a software format for computer-assisted design or CAD);
entity C is the computer workstation of an economist, for example, which may interact with
the workstation G of a supplier of construction products, in which case the data from a catalog of the construction products chosen for the design (such as the reference, composition, thermal and/or acoustic properties of the products) must again be entered (often manually) for the initial development of the project in digital form;
entity D is the workstation of the specifier for the project, who enters the data for the specifications and/or standards in effect in a given country and therefore also chooses the construction products meeting these requirements;
entity E can be one or more computer workstations of subcontractors, and entity F the workstation of the end operator.

The invention improves this situation.

For this purpose, it first proposes a method for enhancing a digital model of a building using computer means. The method of the invention comprises the steps of:
a) analyzing the digital model to identify the elements that are components of the building and have specific characteristics in the building,
b) defining construction products having properties corresponding to said characteristics, and
c) enhancing the digital model by adding, for every component element of the model, data from at least one list of suitable construction products.

For example, the elements of the building may be a wall, a partition, a slab, a window, a door, or a ceiling, and the specific characteristics of such elements may comprise a value such as a desired interior thermal insulation value, a desired exterior thermal insulation value, a desired sound insulation value, a desired fire resistance value, or some other value.

Advantageously, these characteristics are treated as variables to be configured (at least in steps a) and b)).

Advantageously, in the enhanced digital model, the data from the abovementioned list of suitable construction products then comprise, for each product, at least a product identifier, an indication of the product properties, and an indication of the product characteristics.

The choice of appropriate construction products may be made as follows: the construction products can be stored in a first database of at least one supplier, with properties specific to these products. Thus the implementation in the above step b) preferably uses this first database. Similarly, the specific characteristics of the building elements may be defined in specifications or be stored in a second database of regulations and standards, and the implementation of at least one of steps a) and b) then uses this second database.

The invention also relates to a centralized software application which allows exchanging data between different preexisting software components. In such an embodiment, there can be at least:
a first software application for designing the model, which when executed yields a digital file representing the model,
a second application, which when executed yields catalog data for the construction products,
a third application, which when executed yields specifications data.

In an advantageous embodiment, such a centralized software application is also provided which cooperates with said first, second, and third applications, and which, when executed, based on the file representing the model and having as input the abovementioned data from the catalog of construction products and from the specifications, outputs a digital file representing the model and additionally enhanced with data from at least one list of construction products chosen as a function of the catalog data and the specifications data.

Advantageously, at least some of the interactions between the centralized application and the first, second, and third applications are executed according to the IFC standard.

Advantageously, there is a preliminary step of verifying the completeness of the data in the digital model, before it is enhanced.

The invention therefore relates to a computer program comprising instructions for implementing the above method when this program is executed by a processor. Such a computer program includes at least the centralized software application described above.

The invention also relates to a device comprising a computer means for enhancing a digital model of a building, wherein this computer means carries out the above method. Typically, such a device can comprise a memory for storing the code for the instructions of the computer program in the sense of the invention, a processor for executing these instructions, and access to construction product data including at least some properties of these products. An exemplary embodiment of such a device will be presented below with reference to FIG. 6.

Thus the invention provides a response to the need for collaborative project development based on a digital model (or BIM for Building Information Model), and, in an advantageous embodiment, using the IFC (Industry Foundation Classes) standard developed by the international association IAI-Building Smart which defines a neutral format for exchanging and archiving the data of a digital building model. This IFC standard (registered by ISO) is now offered for importing/exporting in most newer generation CAD software for the construction industry.

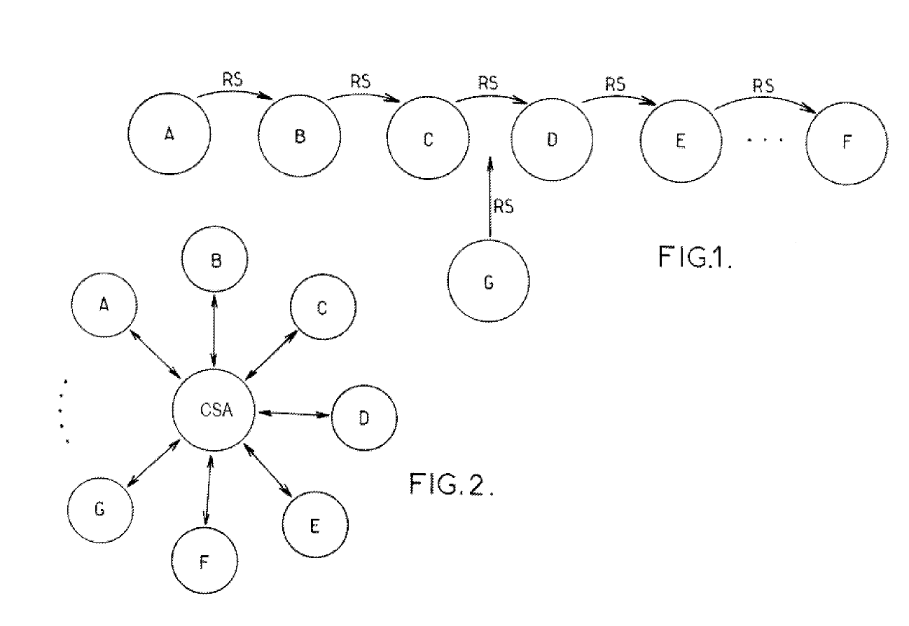

With reference to FIG. 2 and using the example in FIG. 1 concerning a plurality of entities A to G involved in a building construction project, the structure of the exchanges between these different entities is improved due to the use of a software application CSA that is centralized in the sense of the invention. Here, the approach is based on sharing a single source of information stored in an enhanced digital model BIM (Building Information Model) in the IFC standard format.

One will recall that the construction products and systems are a key element to accurately determining the energy performance or environmental impacts of a building. To achieve the fixed goals, the choice of solutions to be applied must be established in the pre-design phase. The products and systems are determined during the detailed design phase. Their properties and geometries are directly integrated into a semantic data model, in the sense of the invention, to provide the calculation software with easy access to the information.

One of the advantages of the invention is the digital availability of information on the products and systems. For all parties in the chain (specifiers, architects or design engineers, distributors, companies), this solution allows:
convergence between the specific trade tools and the digital information on the products;
better visibility of construction products (particularly for innovative systems),
accelerated availability of market products;
improved specifications process.

This advantage is even more pronounced when the specifiers require the construction of low-energy buildings. The model is enhanced in the sense of the invention, particularly due to the data on the building's energy performance.

Of course there are existing electronic catalogs from suppliers, but these are insufficient for effective use with a digital model. These catalogs generally offer text descriptions of products and systems with a set of multimedia documents. A specifier often finds that defining the right configuration for a system, based on the type of building, its geographical location, applicable local regulations, desired technological performance, or other aspects, is a complicated task and gives rise to errors when based solely on such textual information.

The enhanced model solution offered by the invention consists of providing specifiers with electronic catalogs, for example in the form of plugins compatible with the largest possible number of the software packages used by the parties involved in the project (for different fields: architecture, structure, thermal, acoustics, etc.). To develop these plugins, the use of the IFC standard to define the rules for assembling the products and systems in a single format is proposed, as it is neutral and compatible with the most types of digital modeling software.

However, the IFC standard only offers a static and fixed description of the products, while defining a construction system product requires a parametric solution for automatically adapting and integrating the system into the digital building model, according to the geographic, spatial, technological, and regulatory constraints as well as the choices of the specifier.

Another advantage of the invention therefore relates to expressing, through a parametric approach and with the IFC standard:
the type and number of components of a system (for example the number of sections in a slab or wall), which vary according to the context of the system's integration into the building;
the position of the components of a system, which vary according to the geometry of the building construction elements.

These data can then advantageously be processed by the software of the invention as variables to be specified. The software of the invention, as a centralized software application, therefore acts as the “configurator” of the IFC standard.

Other features and advantages of the invention will be apparent from examining the following detailed description and the attached drawings, in which, in addition to FIGS. 1 and 2 discussed above:

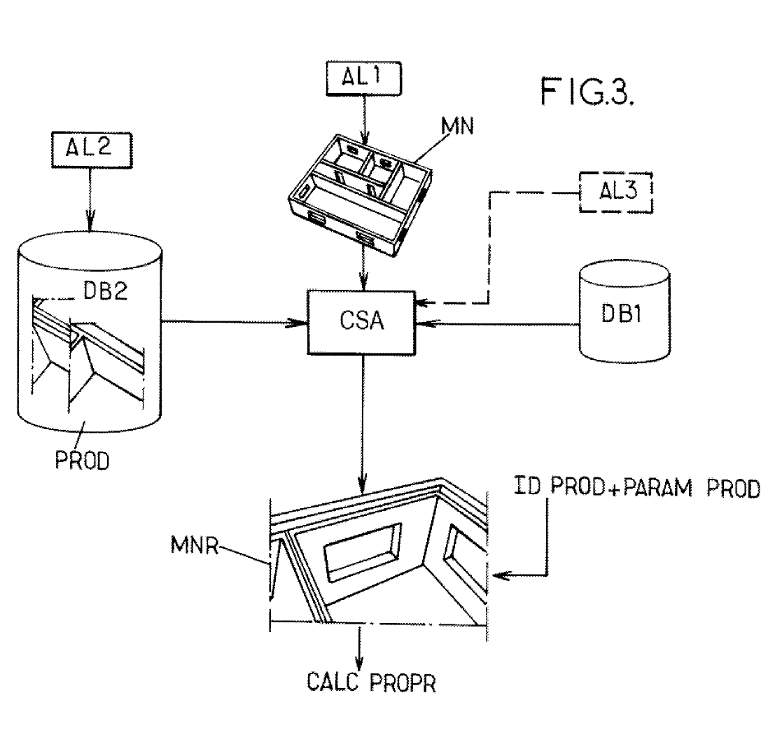

FIG. 3 schematically represents one embodiment of an implementation of a centralized software application,

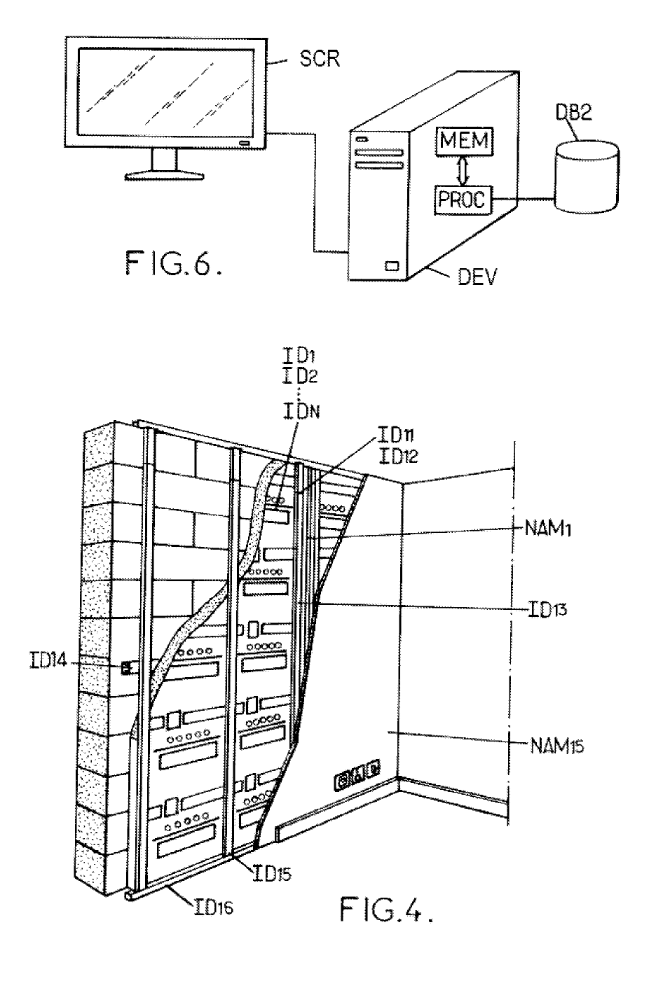

FIG. 4 represents a display on a screen of a system suitable for an enhanced digital model of the invention,

FIG. 5 illustrates one embodiment of the steps of the method of the invention, and

FIG. 6 schematically illustrates a device for implementing the method of the invention.

First we will refer to FIG. 3, in which a centralized software application CSA in the sense of the invention receives:
a preliminary drawing MN, for example from the workstation of an architect, designed using a CAD application denoted AL1 in FIG. 3,
data from a database DB2 of the products and systems (PROD) of a supplier; this database DB2 may be organized by executing an application AL2 described below; it at least contains multimedia data on the products and systems and their references, and
data from a database DB1 of regulations and standards, containing data on the performance and rules to be met by the products and systems.

Advantageously, data issuing from an application AL3 which processes the specifications from the specifier may further enhance the data processed by the centralized application CSA (dotted arrow). Even so, the centralized application CSA is preferably stored on the workstation of the specifier, as will be seen below in an embodiment.

The centralized application CSA then delivers an enhanced digital model MNR in the IFC standard and containing but not limited to the references for the products and systems chosen (ID PROD), as well as their characteristics (heat insulation, sound insulation, etc.) as specified variable values. This enhanced model MNR can then be used, for example for calculations concerning:
the general thermal or acoustic properties,
the structure
the environmental impact,
or other.

The details of assembling a system chosen for its adaptation to a digital model are represented in FIG. 4, as an example. For the wall represented, the references 101 to IDN may denote materials such as:
roll insulation GR32 Kraft-faced (ID1),
roll insulation GR32 Kraft and aluminum-faced (ID2),
monospace 35 Kraft-faced
monospace 35 contact, etc.

It is understood that the terms “GR32” or “monospace” are the catalog labels of the supplying manufacturer.

The references ID11 and ID12 indicate joint plates having different references (30 or 50). The reference NAM1 indicates one or more electrical ducts and/or plumbing conduits, but with no specific catalog reference. The reference ID13 indicates the furring. The reference ID14 indicates a support. The reference NAM15 designates the sheetrock, but again with no specific catalog reference. The reference ID15 indicates a U-clip and the reference ID16 indicates a felt strip.

Again with reference to FIG. 3, the application AL2, for the supplying manufacturers, consists of a framework for developing the configurators for construction products and systems in the IFC standard. This framework allows the supplier manufacturers to develop a configuration for their construction systems in the IFC standard, not only with the product and system characteristics according to their usual implementation rules (defining variables specific to the items, products and systems), but also with the rules for selecting and assembling the components (products/items) as a function of the integration context. To apply the latter more specific rules, the following are defined:
geometric variables related to the CAD design;
project variables related to the CAD design, such as:
   building location (country, site, etc.);
   building type (new/old, individual/multi-unit, etc.);
   types of areas and spaces (office, kitchen, bathroom, etc.);
   types of construction elements (load-bearing wall, non-load-bearing wall, floor, partition, door, or other element);
but also project variables not defined by the CAD application, such as:
   types of construction elements (for example in terms of exterior insulation ITE or interior insulation ITI);
   thermal performance (for example RT-2005 (the French 2005 thermal regulations), ZNE (zero net energy), LEB (low-energy building));
   environmental performance,
   acoustic performance, etc.

This computer application consists of:
a database format for storing the variables of the systems;
a user interface for entering and/or importing the corresponding values;
a script language for describing the rules for selecting and assembling the systems;
a programming library, for example a SDK (Software Development Kit) for reading and writing data in the IFC standard.

Thus one of the first effects of running the application AL2 is to make the contents of the database DB2 compatible with the queries and lookups that the specifiers may perform using the centralized software application CSA, as described below.

For the specifiers, the centralized software application (via a possible interface AL3) processes the entire digital model of a building construction project (BIM-IFC) on the basis of a CAD model of a project drawing (saved in IFC format in an advantageous implementation of the invention) and using initial CAD software, as described below.

A first step consists of verifying the drawing after the CAD model is loaded, in particular the quality and completeness of the IFC data, and allowing the specifier to add the following information where necessary:
geographical location of the project;
new construction project or renovation;
building types (single, multi-unit, other), areas (kitchen, living room, office, bathrooms) and partitioning elements (walls, partitions, slabs);
applicable local regulations.

After this step, the model is saved in the IFC standard, for reloading into the initial CAD software.

A second step consists of adding data to the project specifications. For each space in the building, at least one of the following operations may be conducted:
choosing a strategy, particularly for sound, thermal, or other insulation: for example ITI (for interior thermal insulation) or ITE (for exterior thermal insulation), Spread (interior or exterior), or other;
specifying the target technological performance (thermal, acoustic, fire resistance, etc.).

At the end of this step, the model is also saved.

A third step involves choosing the products and systems from among those offered by the supplier. For each construction element (wall, partition, slab, window, door, ceiling, or other) that the user selects and wants to configure, vendor solutions are proposed that are consistent with the specifications defined in the first and second steps.

A fourth step concerns:
automatic layout (geometric assembly) of the product and items in the digital model for the project; and
automatic integration of the characteristics of the products and items (reference identifier, properties, multimedia links, etc.) in the digital model.

A fifth step concerns the use of the detailed digital model. The model enhanced with the detailed descriptions of the products and systems (geometry and characteristics) may again be saved in the IFC standard for later use with analysis software that is also compatible with the IFC format, for example in order to conduct thermal or acoustic calculations, an environmental evaluation, a structural evaluation, etc.

FIG. 5 summarizes the steps of the above method.

For example, using the CAD software ArchiCAD® (from Graphisoft®), an architect creates a drawing which is the CAD model of a single-family house. He saves this model in IFC format in a file FI1, in step S0, which can be named for example “Drawing_initial.iƒc”.

In the next step S1, the software of the invention verifies the drawing. This software of the invention, for example stored on the workstation of a specifier (who may be the architect or another party in the design-construction chain), loads and checks the file FI1, with the following options:
3D view, isolation of each construction element to verify the properties;
verification of coordinates of the geographic location of the project; if they are incorrect, correction via a user interface;
verification and possible correction of building types (residential, single-family housing, etc.);
selection of areas to which he wants to apply a configuration in the sense of the invention; the interface automatically identifies the areas adjacent to the selected areas;
verification and possible correction of the types of the selected and adjacent areas (between an office, bathroom, bedroom, or entrance hall);
selection of construction elements that separate or divide these spaces and verification and possible correction of associated characteristics: simple partition, exterior wall, load-bearing interior wall;
saving the file FI1 in the IFC standard, under the name “Drawing_corrected.iƒc” in step S2.

The next step S3 consists of filling in the specifications for the project. The specifier continues with the software application by reloading the file FI2 in order to add specifications for his construction project. For each area, he can indicate:
whether it is a new construction project or a renovation;
what type of thermal performance is desired;
what insulation strategy is desired: ITI or ITE (Interior or Exterior Thermal Insulation).

In step S4, the file FI3 which additionally contains the data from the specifications is saved under the name “Drawing_LEB_Specs.iƒc”.

In the next step S5, the specifier continues to run the software, loading the file FI3 (Drawing_LEB_Specs.iƒc) in order to specify the system types he wants to apply, based on the choices offered by the supplying manufacturer. For each element (walls, partitions, or other) selected between or dividing the spaces, the software automatically proposes one or more applicable construction products or systems (PROD), taking into account:
the type of building and its geographical location;
the types of spaces separated by the element;
the target thermal regulations (LEB);
the desired insulation strategy (ITI/ITE);
geometric/spatial constraints on the room.

The specifier can choose from among these products and systems (such as the wall represented in FIG. 4). The set of these choices is saved in step S6 in the file FI4, named “Drawing_LEB_PROD.iƒc”.

In step S7, for a selection or for the set of selected elements to be configured for which the choice of systems has been made, the software generates detailed IFC models for each product or system integrated into the entire CAD model for the project. For each product or system, the following elements are created automatically:
the assembled geometry of the system components (products-items);
the technical characteristics of the products-items, with at least:
   their reference;
   the configured quantities of the items and sub-items, calculated automatically;
   the references for the Environmental Product Declaration and Safety Information Sheets, for calculating the environmental impact.

The configured project is saved in a detailed digital model BIM-IFC in step S8.

In step S9, the configured project can then be used by other parties for other studies, for example:
loading the BIM-IFC file by the Climawin® software (BBS Slama® for a general regulatory thermal analysis of the project;
or loading and exporting to other formats for other analyses, such as those done by the following software products:
   Elodie® (CSTB) for analyzing the total environmental impact of the project;
   Batimax® for a detailed economic analysis, for construction site preparation.

Of course, the invention is not limited to the embodiments described above in the examples; it extends to other variants.

1: A method for enhancing a digital model of a building using computer means, comprising the steps of:
a) analyzing the digital model to identify the elements that are components of the building and have specific characteristics in the building,
b) defining construction products having properties corresponding to said characteristics, and
c) enhancing the digital model by adding, for every component element of the model, data from at least one list of suitable construction products.

2: The method according to claim 1, wherein said characteristics are processed in steps a) and b) as configured variables.

3: The method according to claim 1, wherein the construction products are stored in a first database of at least one supplier, with properties specific to said products, and wherein the implementation in step b) uses the first database.

4: The method according to claim 1, wherein the specific characteristics of the building elements are stored in a second database of regulations and standards, and wherein the implementation of at least one of steps a) and b) uses the second database.

5: The method according to claim 1, wherein it comprises at least:
a first software application for designing the model, which when executed yields a digital file representing the model,
a second application, which when executed yields catalog data for the construction products,
a third application, which when executed yields specifications data, wherein a centralized software application is also provided which cooperates with said first, second, and third applications, and which, when executed, based on the file representing the model and having as input the abovementioned data from the catalog of construction products and from the specifications, outputs a digital file representing the model and enhanced with data from at least one list of construction products chosen as a function of the catalog data and specifications data.

6: The method according to claim 5, wherein at least some of the interactions between the centralized application and the first, second, and third applications are executed according to the IFC standard.

7: The method according to claim 1, wherein it comprises a prior step of verifying the completeness of the data in the digital model.

8: The method according to claim 1, wherein the building elements are in a list of at least a wall, a partition, a slab, a window, a door, a ceiling;
and wherein the specific characteristics of said elements in the building comprise at least one value chosen from among a desired interior thermal insulation value, a desired exterior thermal insulation value, a desired sound insulation value, and a desired fire resistance value.

9: The method according to claim 1, wherein the data from said list of suitable construction products comprise, for each product, at least one product identifier, an indication of the product properties, and an indication of the product characteristics.

10: A non-transitory computer readable storage medium, having stored thereon a computer program comprising instructions for implementing the method according to claim 1, when this program is executed by a processor.

11: A device comprising a computer for enhancing a digital model of a building, wherein said computer carries out the method according to claim 1.

12: The device according to claim 11, wherein it comprises a memory for storing code for instructions of the method, a processor for executing said instructions, and an access to construction product data including at least some properties of said products.
